(19) United States
(12) Patent Application Publication
(10) Pub. No.: US 2024/0379929 A1
(43) Pub. Date: Nov. 14, 2024

(54) METHODS OF MANUFACTURING LITHIUM METAL NEGATIVE ELECTRODES AND BATTERIES INCLUDING THE SAME

(71) Applicant: GM GLOBLAL TECHNOLOGY OPERATIONS LLC, Detroit, MI (US)

(72) Inventors: Sayed Youssef Sayed NAGY, Troy, MI (US); Caleb REESE, Ferndale, MI (US)

(21) Appl. No.: 18/316,836

(22) Filed: May 12, 2023

(51) Int. Cl. H01M 4/04; H01M 4/133; H01M 4/134; H01M 4/1393; H01M 4/1395; H01M 4/66; H01M 4/80

(52) U.S. Cl. CPC H01M 4/0404; H01M 4/0471; H01M 4/133; H01M 4/134; H01M 4/1393; H01M 4/1395; H01M 4/661; H01M 4/663; H01M 4/667; H01M 4/80; H01M 2004/027; H01M 10/0525

(57) ABSTRACT

A battery that cycles lithium ions includes a negative electrode current collector and a lithium metal layer deposited thereon. The negative electrode current collector has a layered structure including a metal substrate and a carbon layer formed in situ on the metal substrate. The negative electrode current collector includes a plurality of perforations extending therethrough. The lithium metal layer is chemically bonded to the carbon layer of the negative electrode current collector. The negative electrode current collector is manufactured via a method that includes a photolithography process, a pyrolysis process, and a surface functionalization process.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to methods of manufacturing lithium metal negative electrodes for batteries that cycle lithium ions and, more particularly to methods of manufacturing perforated metal current collectors with lithophilic surfaces for lithium metal negative electrodes.

Lithium batteries are used in a wide variety of portable electronic devices and are a promising candidate to fulfill the requirements of electric vehicles, including hybrid electric vehicles, owing to their high energy and power densities. Secondary lithium batteries generally include a negative electrode, a positive electrode, and an electrolyte that provides a medium for the conduction of lithium ions between the negative and positive electrodes during discharge and charge of the battery. During manufacture, the electrodes are oftentimes deposited in the form of thin layers on electrically conductive metal current collectors.

### SUMMARY

A method of manufacturing a lithium metal negative electrode for a battery that cycles lithium ions comprises steps (a)-(h). In step (a), a photosensitive material layer is formed on a surface of a metal substrate. In step (b), a mask is positioned over the metal substrate and the photosensitive material layer, the mask including a plurality of apertures extending therethrough such that the photosensitive material layer includes a covered region and a plurality of uncovered regions corresponding to the plurality of apertures in the mask. In step (c), the uncovered regions of the photosensitive material layer are exposed to radiation. In step (d), the uncovered regions of the photosensitive material layer are removed from the metal substrate such that the metal substrate includes a decorated region corresponding to the covered region of the photosensitive material layer and a plurality of bare regions corresponding to the uncovered regions of the photosensitive material layer. In step (e), the plurality of bare regions are removed from the metal substrate by etching such that the photosensitive material layer and the metal substrate include a plurality of perforations extending therethrough. In step (f), the covered region of the photosensitive material layer remaining on the surface of the metal substrate is pyrolyzed to remove functional groups therefrom and transform the covered region of the photosensitive material layer into a carbon layer. In step (g), a lithophilic surface is formed on the carbon layer by heating the metal substrate and the carbon layer in an oxygen-containing environment. In step (h), lithium is applied to the metal substrate over the carbon layer to form the lithium metal negative electrode, wherein the lithium is applied to the metal substrate such that a continuous layer of lithium chemically bonds to the lithophilic surface on the carbon layer.

The photosensitive material layer may comprise an organic polymer. In such case, the photosensitive material layer may comprise, on an atomic basis, greater than or equal to about 40% carbon.

Exposing the uncovered regions of the photosensitive material layer to radiation in step (c) may comprise exposing the uncovered regions of the photosensitive material to visible light, ultraviolet (UV) light, electron beam radiation, X-ray radiation, or a combination thereof.

Exposing the uncovered regions of the photosensitive material layer to radiation in step (c) may render the uncovered regions soluble in a liquid developer. In such case, the uncovered regions of the photosensitive material layer may be removed from the surface of the metal substrate in step (d) by washing the metal substrate with the liquid developer.

The metal substrate may be made of copper and the plurality of bare regions may be removed from the metal substrate in step (e) by electrochemical etching.

Pyrolyzing the covered region of the photosensitive material layer in step (f) may comprise heating the covered region of the photosensitive material layer in a hydrogen-containing environment at a temperature of greater than or equal to about 800 degrees Celsius and less than or equal to about 1000 degrees Celsius.

The carbon layer formed on the surface of the metal substrate in step (f) may comprise, by weight, greater than 95% carbon.

The metal substrate may have a thickness of greater than or equal to about 1 micrometer and less than or equal to about 4 millimeters. The carbon layer may have a thickness of greater than or equal to about 10 nanometers and less than or equal to about 100 nanometers.

Forming the lithophilic surface on the carbon layer in step (g) may comprise heating the metal substrate and the carbon layer in an oxygen-containing environment at a temperature of greater than or equal to about 200 degrees Celsius and less than or equal to about 600 degrees Celsius. The lithophilic surface formed on the carbon layer may comprise a plurality of oxygen-containing reactive groups covalently bonded to the carbon layer.

The lithium may be applied to the metal substrate in step (h) by applying a solid lithium metal layer to the metal substrate over the carbon layer or by pouring molten lithium on the metal substrate over the carbon layer.

The plurality of perforations may have at least one cross-sectional dimension of greater than or equal to about 2 micrometers and less than or equal to about 1 millimeter.

The lithium may be applied to the metal substrate in step (h) such that the lithium extends into the plurality of perforations.

The lithium metal negative electrode may have a thickness of greater than or equal to about 1 micrometer to less than or equal to about 30 micrometers.

The method may further comprise, after step (h), assembling the lithium metal negative electrode into a battery.

A method of manufacturing a lithium metal negative electrode for a battery that cycles lithium ions comprises steps (a)-(h). In step (a), a photosensitive material layer is formed on a surface of a metal substrate. In step (b), a mask is positioned over the metal substrate and the photosensitive material layer, the mask including a plurality of apertures extending therethrough such that the photosensitive material layer includes a covered region and a plurality of uncovered regions corresponding to the plurality of apertures in the mask. In step (c), the uncovered regions of the photosensitive material layer are exposed to radiation. In step (d), the uncovered regions of the photosensitive material layer are removed from the metal substrate such that the metal substrate includes a decorated region corresponding to the covered region of the photosensitive material layer and a plurality of bare regions corresponding to the uncovered regions of the photosensitive material layer. In step (e), the plurality of bare regions are removed from the metal substrate by etching such that the metal substrate includes a plurality of perforations extending therethrough. In step (f), the covered region of the photosensitive material layer remaining on the surface of the metal substrate is pyrolyzed to remove functional groups therefrom and transform the covered region of the photosensitive material layer into a carbon layer. In step (g), a lithophilic surface is formed on the carbon layer by heating the metal substrate and the carbon layer in an oxygen-containing environment, the lithophilic surface comprising a plurality of -hydroxyl groups and/or -carboxyl groups covalently bonded to the carbon layer. In step (h), lithium is applied to the metal substrate over the carbon layer to form the lithium metal negative electrode, wherein the lithium is applied to the metal substrate such that a continuous layer of lithium chemically bonds to the lithophilic surface on the carbon layer via a plurality of hydrogen bonds.

A battery that cycles lithium ions comprises a negative electrode current collector and a lithium metal layer deposited on the negative electrode current collector. The negative electrode current collector has a first major surface, an opposite second major surface, and a plurality of perforations extending therethrough. The plurality of perforations are defined by wall surfaces extending from the first major surface to the second major surface of the negative electrode current collector. The negative electrode current collector has a layered structure comprising a metal substrate and a carbon layer formed in situ on the metal substrate. The carbon layer defines the first major surface of the negative electrode current collector. The lithium metal layer is deposited on the first major surface of the negative electrode current collector. The lithium metal layer is chemically bonded to the carbon layer via a plurality of hydrogen bonds.

The plurality of perforations may have at least one cross-sectional dimension of greater than or equal to about 2 micrometers and less than or equal to about 1 millimeter.

The negative electrode current collector may have a thickness of greater than or equal to about 1 micrometer and less than or equal to about 4 millimeters.

The carbon layer may have a thickness of greater than or equal to about 10 nanometers and less than or equal to about 100 nanometers.

The lithium metal layer may extend into the plurality of perforations in the negative electrode current collector, from the first major surface toward the second major surface thereof. The lithium metal layer may have a thickness of greater than or equal to about 1 micrometer to less than or equal to about 30 micrometers.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by battery pack that includes multiple battery modules.

FIG. 2 is a schematic cross-sectional view of a portion of one of the battery modules of FIG. 1, the battery module including multiple battery cells arranged in a stack.

FIG. 3 is a schematic cross-sectional view of a battery that cycles lithium ions, the battery comprising a lithium metal negative electrode disposed on a perforated current collector.

FIG. 4 is a schematic front view of the perforated current collector of FIG. 3.

FIG. 5 is an enlarged cross-sectional view of a portion of the lithium metal negative electrode and the perforated current collector of FIG. 3.

FIGS. 6A-6E schematically depict steps in a method of manufacturing the lithium metal negative electrode and the perforated current collector of FIG. 3.

In the drawings, reference numbers may be reused to identify similar and/or identical elements.

### DETAILED DESCRIPTION

The presently disclosed methods may be used to manufacture lithium metal negative electrodes for batteries that cycle lithium ions and may help facilitate the production of relatively large-scale batteries.

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

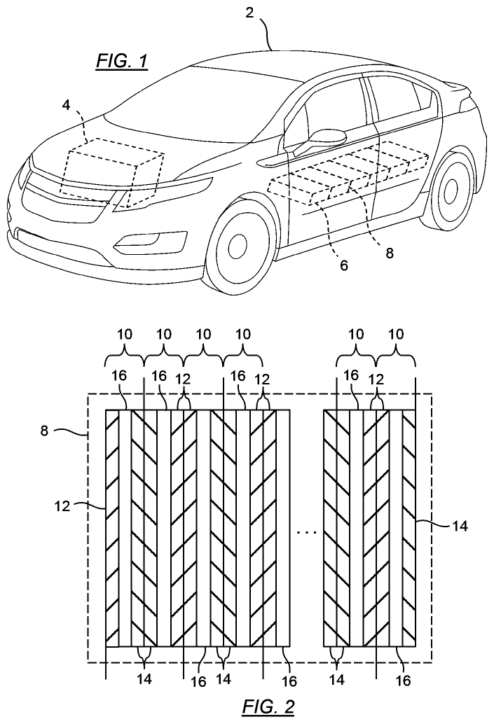

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14 spaced apart by a separator layer 16. The negative electrode layers 12 are disposed on an in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative and positive electrode current collectors 13, 15 are double sided and include negative or positive electrode layers 12, 14 on both sides thereof. In this arrangement, adjacent negative electrode layers 12 and positive electrode layers 14 share a single negative or positive current collector 13, 15.

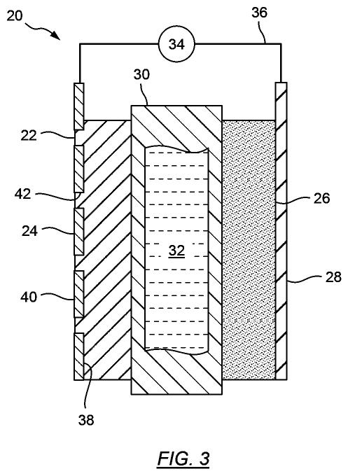

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a lithium metal negative electrode 22 disposed on a negative electrode current collector 24, a positive electrode 26 disposed on a positive electrode current collector 28, a separator 30, and an electrolyte 32. In practice, the negative electrode current collector 24 and the positive electrode current collector 28 are electrically coupled to a power source or load 34 (e.g., the electric motor 12) via an external circuit 36. The negative and positive electrodes 22, 26 are formulated such that, when the battery 20 is at least partially charged, an electrochemical potential difference is established between the negative and positive electrodes 22, 26. During discharge of the battery 20, the electrochemical potential established between the negative and positive electrodes 22, 26 drives spontaneous redox reactions within the battery 20 and the release of lithium ions and electrons at the negative electrode 22. The released lithium ions travel from the negative electrode 22 to the positive electrode 26 through the separator 30 and the ionically conductive electrolyte 32, and the electrons travel from the negative electrode 22 to the positive electrode 26 via the external circuit 36, which generates an electric current. After the negative electrode 22 has been partially or fully depleted of lithium, the battery 20 may be charged by connecting the negative and positive electrodes 22, 26 to the power source 34, which drives nonspontaneous redox reactions within the battery 20 and the release of the lithium ions and the electrons from the positive electrode 26. The repeated discharge and charge of the battery 20 may be referred to herein as “cycling,” with a full charge event followed by a full discharge event being considered a full cycle.

The negative electrode current collector 24 is electrically conductive and provides an electrical connection between the lithium metal negative electrode 22 and the external circuit 36. Referring now to FIGS. 3, 4, and 5, the negative electrode current collector 24 is macroporous and has a first major surface 38, an opposite second major surface 40, and a plurality of perforations 42 extending therethrough. The plurality of perforations 42 are defined by wall surfaces 44 extending from the first major surface 38 to the second major surface 40 of the negative electrode current collector 24. The plurality of perforations 42 may help ensure good bonding between the lithium metal negative electrode 22 and the negative electrode current collector 24 and may help prevent delamination of the lithium metal negative electrode 22 from the negative electrode current collector 24 during cycling of the battery 20.

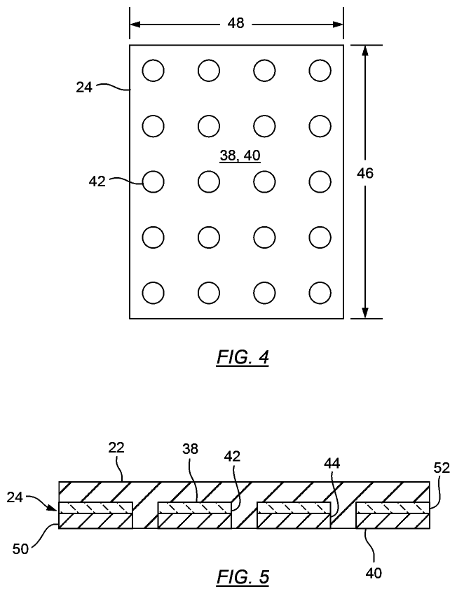

As shown in FIG. 4, the plurality of perforations 42 may be substantially uniformly spaced apart from one another within the negative electrode current collector 24 and may exhibit substantially the same cross-sectional shape. In FIG. 4, the plurality of perforations 42 each have a circular cross-sectional shape. In other embodiments, the cross-sectional shape of the plurality of perforations 42 may be elliptical or polygonal, e.g., triangular, square, rectangular, hexagonal, quadrilateral, octagonal, or a combination thereof. The plurality of perforations 42 each may have at least one cross-sectional dimension of greater than or equal to about 2 micrometers and less than or equal to about 1 millimeter. For example, the plurality of perforations 42 each may have a circular cross-sectional shape and a diameter of greater than or equal to about 2 micrometers and less than or equal to about 1 millimeter. The plurality of perforations 42 may provide the negative electrode current collector 24 with a porosity or void volume fraction of greater than or equal to about 0.5 to less than or equal to about 0.99. The negative electrode current collector 24 may have a length 46 extending from a first end to an opposite second end thereof and a width 48 extending from a first side to an opposite second side thereof. The length 46 and the width 48 of the negative electrode current collector 24 may be the same or different. The length 46 and the width 48 of the negative electrode current collector 24 each may be greater than or equal to about 6 centimeters, about 10 centimeters, or about 15 centimeters and less than or equal to about 60 centimeters, about 50 centimeters, or about 30 centimeters.

As shown in FIG. 5, the negative electrode current collector 24 has a layered structure and includes a metal substrate 50 and an overlying carbon layer 52. The first major surface 38 of the negative electrode current collector 24 is defined by the carbon layer 52 and the second major surface 40 of the negative electrode current collector 24 is defined by the metal substrate 50. The plurality of perforations 42 extend entirely through the metal substrate 50 and the carbon layer 52 such that the wall surfaces 44 are defined by both the metal substrate 50 and the carbon layer 52. The carbon layer 52 may help ensure good bonding between the lithium metal negative electrode 22 and the negative electrode current collector 24.

The metal substrate 50 is made of an electrochemically inactive metal. For example, the metal substrate 50 may be made of copper or a copper-based material. The carbon layer 52 comprises carbon and may consist essentially of or consist of carbon. For example, the carbon layer 52 may comprise, by weight, greater than 95%, greater than 97%, or greater than 99% carbon. The negative electrode current collector 24 may have a thickness defined between the first major surface 38 and the second major surface 40 thereof of greater than or equal to about 1 micrometer, about 5 micrometers, or about 10 micrometers and less than or equal to about 4 millimeters, about 60 micrometers, or about 30 micrometers. The carbon layer 52 may have a thickness of greater than or equal to about 10 nanometers and less than or equal to about 100 nanometers.

The lithium metal negative electrode 22 is electrochemically active and is disposed on the first major surface 38 of the negative electrode current collector 24. The lithium metal negative electrode 22 comprises lithium (Li) and may consist essentially of or consists of lithium. For example, the lithium metal negative electrode 22 may comprise, by weight, greater than 97% lithium, or optionally greater than 99% lithium. The lithium metal negative electrode 22 may be substantially free of elements or compounds that undergo a reversible redox reaction with lithium during operation of the battery 20. For example, the lithium metal negative electrode 22 may be substantially free of an intercalation host material that is formulated to undergo the reversible insertion or intercalation of lithium ions or an alloying material that can electrochemically alloy and form compound phases with lithium. In addition, the lithium metal negative electrode 22 may be substantially free of a conversion material or an alloy material that can electrochemically alloy and form compound phases with lithium. Some examples of materials that may be intentionally excluded from the lithium metal negative electrode 22 include carbon-based materials (e.g., graphite, activated carbon, carbon black, and graphene), silicon and silicon-based materials, tin oxide, aluminum, indium, zinc, cadmium, lead, germanium, tin, antimony, titanium oxide, lithium titanium oxide, lithium titanate, lithium oxide, metal oxides (e.g., iron oxide, cobalt oxide, manganese oxide, copper oxide, nickel oxide, chromium oxide, ruthenium oxide, and/or molybdenum oxide), metal phosphides, metal sulfides, and metal nitrides (e.g., phosphides, sulfides, and/or nitrides or iron, manganese, nickel, copper, and/or cobalt). The lithium metal negative electrode 22 may be substantially free of a polymeric binder. Some examples of polymeric binders that may be intentionally excluded from lithium metal negative electrode 22 include polyvinylidene fluoride (PVdF), ethylene propylene diene monomer (EPDM) rubber, styrene butadiene rubber (SBR), carboxymethyl cellulose (CMC), and polyacrylic acid.

As shown in FIGS. 3 and 5, the lithium metal negative electrode 22 is disposed on the first major surface 38 of the negative electrode current collector 24 and may extend at least partway into the plurality of perforations 42. For example, the lithium metal negative electrode 22 may extend into the plurality of perforations 42 and entirely through the negative electrode current collector 24, from the first major surface 38 to the second major surface 40 thereof. The lithium metal negative electrode 22 may have a thickness in a range of greater than zero micrometers and less than or equal to 100 micrometers, depending upon the state of charge of the battery 20. The lithium metal negative electrode 22 is chemically bonded to the carbon layer 52 on the first major surface 38 of the negative electrode current collector 24 via a plurality of hydrogen bonds.

The positive electrode 26 is configured to store and release lithium ions during discharge and charge of the battery 20 and comprises an electrochemically active (electroactive) material that can undergo a reversible redox reaction with lithium, e.g., a material that can sufficiently undergo lithium intercalation and deintercalation, alloying and dealloying, or plating and stripping. In one form, the electroactive material of the positive electrode 26 may comprise an intercalation host material that can undergo the reversible insertion or intercalation of lithium ions. In such case, the electroactive material of the positive electrode 26 may comprise a lithium transition metal oxide. For example, the electroactive material of the positive electrode 26 may comprise a layered oxide represented by the formula LiMeO₂, an olivine-type oxide represented by the formula LiMePO₄, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In some embodiments, the electroactive material of the positive electrode 26 may comprise a lithium transition metal oxide selected from the group consisting of lithium cobalt oxide (LCO), lithium manganese oxide (LMO), lithium nickel manganese cobalt oxide (NMC), lithium nickel cobalt aluminum oxide (NCA), lithium nickel cobalt manganese aluminum oxide (NCMA), and lithium manganese iron phosphate (LMFP). In another form, electroactive material of the positive electrode 26 may comprise a conversion material including a component that can undergo a reversible electrochemical reaction with lithium, in which the component undergoes a phase change or a change in crystalline structure accompanied by a change in oxidation state. In such case, the electroactive material of the positive electrode 26 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof. Examples of suitable metals for inclusion in the conversion material of the electroactive material of the positive electrode 26 include iron, manganese, nickel, copper, and cobalt.

The electroactive material of the positive electrode 26 may be intermingled with an electrically conductive agent and a binder. The electrically conductive agent is formulated to provide the positive electrode 26 with good electron percolation and may comprise a carbon-based material. For example, the electrically conductive agent may comprise particles of high surface area carbon black, acetylene black, or graphite, carbon fibers (e.g., carbon nanofibers), carbon nanohorns, carbon nanotubes (e.g., single-wall or multiwall carbon nanotubes), onion-like carbon, graphene (e.g., graphene nanoplatelets), graphene oxide, or a combination thereof. The binder is configured to the positive electrode 26 good cohesive and adhesive properties and may comprise an organic polymer. Examples of organic polymers include polyvinylidene fluoride (PVDF), ethylene propylene diene monomer (EPDM) rubber, styrene butadiene rubber (SBR), carboxymethyl cellulose (CMC), and/or polyacrylic acid (PAA).

The positive electrode current collector 28 is electrically conductive and provides an electrical connection between the positive electrode 24 and the external circuit 38. The positive electrode current collector 28 is made of an electrochemically inactive electrically conductive material, e.g., metal. For example, the positive electrode current collector 28 may be made of copper, copper-based materials, aluminum, aluminum-based materials, nickel, nickel-based materials, iron-based materials (e.g., stainless steel), titanium-based materials, tin-based materials, or a combination thereof. In aspects, the positive electrode current collector 28 may be made of aluminum or an aluminum-based material.

The separator 30 physically and electrically isolates the positive electrode 26 and the negative electrode 22 from each other while permitting lithium ions to pass therethrough. The separator 30 has an open microporous structure and may comprise an organic and/or inorganic material. For example, the separator 30 may comprise a polymer or a combination of polymers. For example, the separator 30 may comprise one or more polyolefins, e.g., polyethylene (PE), polypropylene (PP), polyamide (PA), poly(tetrafluoroethylene) (PTFE), polyvinylidene fluoride (PVdF), and/or poly(vinyl chloride) (PVC). In one form, the separator 30 may comprise a laminate of polymers, e.g., a laminate of PE and PP. In aspects, the separator 30 may comprise a ceramic coating (not shown) disposed on one or both sides thereof. In such case, the ceramic coating may comprise particles of alumina (Al₂O₃) and/or silica (SiO₂).

The electrolyte 32 is ionically conductive and provides a medium for the conduction of lithium ions between the positive electrode 26 and the negative electrode 22. In assembly, the battery 20 is infiltrated with the electrolyte 32 and the positive electrode 26, the separator 30, and the negative electrode 22 are in direct physical contact with the electrolyte 32. The electrolyte 32 may be in the form of a nonaqueous liquid electrolyte, a gel electrolyte, or a solid electrolyte. When the electrolyte 32 is in the form of a liquid, the electrolyte 32 may comprise a nonaqueous liquid electrolyte solution comprising a lithium salt dissolved or ionized in a nonaqueous, aprotic organic solvent or a mixture of nonaqueous, aprotic organic solvents. Examples of lithium salts include LiClO₄, LiAlCl₄, Lil, LiBr, LiSCN, LiBF₄, LiB(C₆H₅)₄, LiAsF₆, LiCF₃SO₃, LiN(CF₃SO₂)₂, Li₂CO₃, LiPF₆, and combinations thereof. Examples of nonaqueous, aprotic organic solvents include cyclic carbonates (i.e., ethylene carbonate, propylene carbonate), acyclic carbonates (i.e., dimethyl carbonate, diethyl carbonate, ethyl methyl carbonate), aliphatic carboxylic esters (i.e., methyl formate, methyl acetate, methyl propionate), γ-lactones (i.e., γ-butyrolactone, γ-valerolactone), acyclic ethers (i.e., 1,2-dimethoxyethane, 1,2-diethoxyethane, ethoxymethoxyethane), and/or cyclic ethers (i.e., tetrahydrofuran, 2-methyltetrahydrofuran). The electrolyte 32 optionally may comprise one or more additives, for example, one or more of lithium difluoro(oxalato)borate (LiDFOB), lithium bis(oxalato)borate (LiBOB), fluoroethylene carbonate (FEC), and vinylene carbonate (VC).

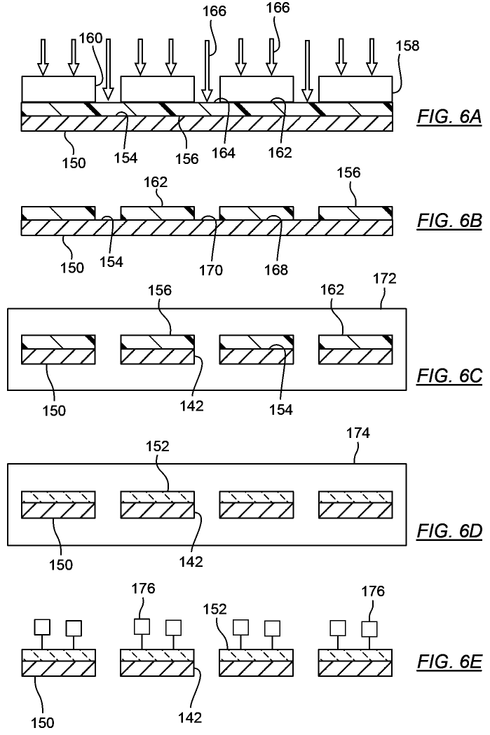

Referring now to FIGS. 6A-6E, the negative electrode current collector 32 is manufactured via a method that includes a photolithography process, a pyrolysis process, and a surface functionalization process. Thereafter, the overlying lithium metal negative electrode 22 is formed on the negative electrode current collector 32. The method of manufacturing the negative electrode current collector 32 and the lithium metal negative electrode 22 may include one or more of the following steps. As shown in FIG. 6A, in a first step, a metal substrate 150 having a major surface 154 is provided and a photosensitive material layer 156 is deposited on the major surface 154 of the metal substrate 150. The metal substrate 150 may have substantially the same composition as that of the metal substrate 50. In addition, the length and the width of the metal substrate 150 may have substantially the same as that of the negative electrode current collector 24.

The photosensitive material layer 156 comprises a photosensitive material, which may comprise an organic polymer. The organic polymer may comprise, on an atomic basis, greater than or equal to about 40%, optionally about 45%, or optionally about 50% carbon (C). In aspects, the photosensitive material may comprise a mixture of an azide quinone, e.g., diazonaphthaquinone (DNQ), and a phenol formaldehyde resin (also known as a novolac resin). The photosensitive material layer 156 may be deposited on the major surface 154 of the metal substrate 150 by applying a thin film of a precursor solution thereto (not shown). The precursor solution may comprise a mixture of the photosensitive material and a solvent. The photosensitive material may constitute, by weight, greater than or equal to 1% and less than or equal to 15% of the precursor solution. Thereafter, the solvent may be removed from the precursor solution, for example, by drying, to form the photosensitive material layer 156. The photosensitive material layer 156 may extend substantially continuously over the major surface 154 of the metal substrate 150 and may have a thickness of greater than or equal to about 15 nanometers and less than or equal to about 150 nanometers.

In a second step, a mask 158 is positioned over the metal substrate 150 and the photosensitive material layer 156. The mask 158 comprises a plurality of apertures 160 extending therethrough. As such, when the mask 158 is positioned over the photosensitive material layer 156, the photosensitive material layer 156 has a covered region 162 that is covered by the mask 158 and a plurality of uncovered regions 164 corresponding to the plurality of apertures 160 in the mask 158.

In a third step, radiation 166 is directed at the photosensitive material layer 156 such that the uncovered regions 164 of the photosensitive material layer 156 are exposed to the radiation 166, while the covered region 162 is not exposed to the radiation 166 because of the position of the mask 158. The uncovered regions 164 of the photosensitive material layer 156 may be exposed to the radiation 166, for example, by exposing the uncovered regions 164 of the photosensitive material layer 156 to visible light, ultraviolet (UV) light, electron beam radiation, X-ray radiation, or a combination thereof. In aspects, the radiation 166 may comprise UV light.

As shown in FIG. 6B, in a fourth step, the mask 158 is removed from the photosensitive material layer 156 and the uncovered regions 164 of the photosensitive material layer 156 that were exposed to the radiation 166 are removed from the metal substrate 150. After the uncovered regions 164 of the photosensitive material layer 156 are removed, the metal substrate 150 has a decorated region 168 corresponding to the covered region 162 of the photosensitive material layer 156 and a plurality of bare regions 170 corresponding to the uncovered regions 164 of the photosensitive material layer 156. The photosensitive material of the photosensitive material layer 156 may be a positive-working photoresist. In such case, exposing the uncovered regions 164 of the photosensitive material layer 156 may to the radiation 166 may decomposes, degrades, and/or render the uncovered regions 164 of the photosensitive material layer 156 soluble in a liquid developer, while the covered region 162 of the photosensitive material layer 156 may remain insoluble in the liquid developer. In such case, the uncovered regions 164 of the photosensitive material layer 156 may be removed from the metal substrate 150 by washing the metal substrate 150 with the liquid developer. The liquid developer may comprise a polar solvent, e.g., water.

As shown in FIG. 6C, in a fifth step, the plurality of bare regions 170 are removed from the metal substrate 150 by etching such that the metal substrate 150 and the photosensitive material layer 156 have a plurality of perforations 142 extending therethrough. The plurality of bare regions 170 may be removed from the metal substrate 150 using an electrochemical etching technique. In such case, the metal substrate 150 including the covered region 162 of the photosensitive material layer 156 are immersed in an electrolyte solution and electrically coupled to a positive pole of an electric current source. At the same time, a metal object made of the same metal as that of the metal substrate 150 is immersed in the electrolyte solution. When the electric current source is turned on, the metal object will function as a cathode and the metal substrate 150 will function as an anode and the metal located in the plurality of bare regions 170 of the metal substrate 150 will be dissolved, creating the plurality of perforations 142. Alternatively, the plurality of bare regions 170 may be removed from the metal substrate 150 by applying an etchant solution thereto. Examples of etchant solutions include aqueous solutions of ammonium hydroxide, nitric acid, ferric chloride (FeCl₃), and combinations thereof.

In a sixth step, the covered region 162 of the photosensitive material layer 156 remaining on the major surface 154 of the metal substrate 150 is pyrolyzed by heating the photosensitive material layer 156 and the metal substrate 150 in controlled environment 172. In aspects, the controlled environment 172 may be a hydrogen-containing environment. For example, the controlled environment 172 may comprise a mixture of an inert carrier gas (e.g., argon) and hydrogen. The hydrogen may constitute, by volume, greater than or equal to about 1% to less than or equal to about 10% of the gas in the controlled environment 172. During the pyrolysis step, the photosensitive material layer 156 and the metal substrate 150 may be heated at a temperature of greater than or equal to about 800 degrees Celsius (° C.) and less than or equal to about 1000° C. in the controlled environment 172 for greater than or equal to about 1 hour, or optionally about 6 hours and less than or equal to about 24 hours, or optionally about 18 hours. In aspects, the photosensitive material layer 156 and the metal substrate 150 may be heated in the controlled environment 172 at a temperature of about 900° C. for about 12 hours. During the pyrolysis step, functional groups are removed from the photosensitive material layer 156 and the covered region 162 of the photosensitive material layer 156 is transformed into a carbon layer 152 (FIG. 6D). In other words, the carbon layer 152 is formed in situ on the major surface 154 of the metal substrate 150. The carbon layer 152 may have substantially the same composition and thickness as that of the carbon layer 52. In addition, the plurality of perforations 142 extending through the metal substrate 150 and the carbon layer 152 may have substantially the same physical attributes as that of the plurality of perforations 42.

As shown in FIG. 6D, in a seventh step, the metal substrate 150 and the carbon layer 152 are heated in an oxygen-containing environment 174 to form a lithophilic surface on the metal substrate 150 and the carbon layer 152. The oxygen-containing environment 174 may comprise, by volume, greater than or equal to about 10%, or optionally about 20% oxygen. In aspects, the oxygen-containing environment 174 may comprise air. During formation of the lithophilic surface, the metal substrate 150 and the carbon layer 152 may be heated in the oxygen-containing environment 174 at a temperature of greater than or equal to about 200° C. and less than or equal to about 600° C. for greater than or equal to about 0.5 hours and less than or equal to about 2 hours. In aspects, the metal substrate 150 and the carbon layer 152 may be heated in the oxygen-containing environment 174 at a temperature of about 450° C. The lithophilic surface formed on the metal substrate 150 and the carbon layer 152 may comprise a plurality of lithophilic moieties 176 (FIG. 6E). The lithophilic moieties 176 may comprise oxygen-containing reactive groups covalently bonded to the surface of the carbon layer 152. Examples of oxygen-containing reactive groups include -hydroxyl groups (—OH), and/or -carboxyl groups (—COOH).

In an eighth step (not shown), lithium is applied to the metal substrate 150 over the carbon layer 152 to form the lithium metal negative electrode 22. After the lithium is applied to the metal substrate 150 over the carbon layer 152, the metal substrate 150 and the carbon layer 152 together define the negative electrode current collector 32. The lithium is applied to the metal substrate 150 such that a continuous layer of lithium is disposed over the metal substrate 150 and the carbon layer 152 that is chemically bonded to the carbon layer 152 (and optionally the metal substrate 150) via a plurality of hydrogen bonds. The lithium may be in solid phase, liquid phase, and/or gas phase when the lithium is applied to the metal substrate 150 by over the carbon layer 152. For example, the lithium may be applied to the metal substrate 150 by over the carbon layer 152 by applying a solid lithium metal layer to the metal substrate 150 by over the carbon layer 152, by pouring molten lithium on the metal substrate 150 by over the carbon layer 152, or by chemical vapor deposition.

In a ninth step, the lithium metal negative electrode 22 and the negative electrode current collector 32 may be combined with the positive electrode 26, the positive electrode current collector 28, the separator 30, and the electrolyte 32 and assembled into the form of the battery 20. In such case, the chemical bonds formed between the lithium in the lithium metal negative electrode 22 and the carbon layer 152 of the negative electrode current collector 32 may help prevent delamination of the lithium metal negative electrode 22 from the negative electrode current collector 32 during cycling of the battery 20.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A method of manufacturing a lithium metal negative electrode for a battery that cycles lithium ions, the method comprising:
(a) forming a photosensitive material layer on a surface of a metal substrate;
(b) positioning a mask over the metal substrate and the photosensitive material layer, the mask including a plurality of apertures extending therethrough such that the photosensitive material layer includes a covered region and a plurality of uncovered regions corresponding to the plurality of apertures in the mask;
(c) exposing the uncovered regions of the photosensitive material layer to radiation;
(d) removing the uncovered regions of the photosensitive material layer from the metal substrate such that the metal substrate includes a decorated region corresponding to the covered region of the photosensitive material layer and a plurality of bare regions corresponding to the uncovered regions of the photosensitive material layer;
(e) removing the plurality of bare regions from the metal substrate by etching such that the photosensitive material layer and the metal substrate include a plurality of perforations extending therethrough;
(f) pyrolyzing the covered region of the photosensitive material layer remaining on the surface of the metal substrate to remove functional groups therefrom and transform the covered region of the photosensitive material layer into a carbon layer;
(g) forming a lithophilic surface on the carbon layer by heating the metal substrate and the carbon layer in an oxygen-containing environment; and
(h) applying lithium to the metal substrate over the carbon layer to form the lithium metal negative electrode, wherein the lithium is applied to the metal substrate such that a continuous layer of lithium chemically bonds to the lithophilic surface on the carbon layer.

2. The method of claim 1, wherein the photosensitive material layer comprises an organic polymer, and wherein the photosensitive material layer comprises, on an atomic basis, greater than or equal to about 40% carbon.

3. The method of claim 1, wherein exposing the uncovered regions of the photosensitive material layer to radiation in step (c) comprises:
exposing the uncovered regions of the photosensitive material to visible light, ultraviolet (UV) light, electron beam radiation, X-ray radiation, or a combination thereof.

4. The method of claim 1, wherein exposing the uncovered regions of the photosensitive material layer to radiation in step (c) renders the uncovered regions soluble in a liquid developer, and wherein the uncovered regions of the photosensitive material layer are removed from the surface of the metal substrate in step (d) by washing the metal substrate with the liquid developer.

5. The method of claim 1, wherein the metal substrate is made of copper, wherein the plurality of bare regions is removed from the metal substrate in step (e) by electrochemical etching.

6. The method of claim 1, wherein pyrolyzing the covered region of the photosensitive material layer in step (f) comprises:
heating the covered region of the photosensitive material layer in a hydrogen-containing environment at a temperature of greater than or equal to about 800 degrees Celsius and less than or equal to about 1000 degrees Celsius.

7. The method of claim 1, wherein the carbon layer formed on the surface of the metal substrate in step (f) comprises, by weight, greater than 95% carbon.

8. The method of claim 1, wherein the metal substrate has a thickness of greater than or equal to about 1 micrometer and less than or equal to about 4 millimeters, and wherein the carbon layer has a thickness of greater than or equal to about 10 nanometers and less than or equal to about 100 nanometers.

9. The method of claim 1, wherein forming the lithophilic surface on the carbon layer in step (g) comprises:
heating the metal substrate and the carbon layer in an oxygen-containing environment at a temperature of greater than or equal to about 200 degrees Celsius and less than or equal to about 600 degrees Celsius, and
wherein the lithophilic surface formed on the carbon layer comprises a plurality of oxygen-containing reactive groups covalently bonded to the carbon layer.

10. The method of claim 1, wherein the lithium is applied to the metal substrate in step (h) by applying a solid lithium metal layer to the metal substrate over the carbon layer or by pouring molten lithium on the metal substrate over the carbon layer.

11. The method of claim 1, wherein the plurality of perforations have at least one cross-sectional dimension of greater than or equal to about 2 micrometers and less than or equal to about 1 millimeter.

12. The method of claim 1, wherein the lithium is applied to the metal substrate in step (h) such that the lithium extends into the plurality of perforations.

13. The method of claim 1, wherein the lithium metal negative electrode has a thickness of greater than or equal to about 1 micrometer to less than or equal to about 30 micrometers.

14. The method of claim 1, further comprising:
after step (h), assembling the lithium metal negative electrode into a battery.

15. A method of manufacturing a lithium metal negative electrode for a battery that cycles lithium ions, the method comprising:
(a) forming a photosensitive material layer on a surface of a metal substrate;
(b) positioning a mask over the metal substrate and the photosensitive material layer, the mask including a plurality of apertures extending therethrough such that the photosensitive material layer includes a covered region and a plurality of uncovered regions corresponding to the plurality of apertures in the mask;
(c) exposing the uncovered regions of the photosensitive material layer to radiation;
(d) removing the uncovered regions of the photosensitive material layer from the metal substrate such that the metal substrate includes a decorated region corresponding to the covered region of the photosensitive material layer and a plurality of bare regions corresponding to the uncovered regions of the photosensitive material layer;
(e) removing the plurality of bare regions from the metal substrate by etching such that the metal substrate includes a plurality of perforations extending therethrough;
(f) pyrolyzing the covered region of the photosensitive material layer remaining on the surface of the metal substrate to remove functional groups therefrom and transform the covered region of the photosensitive material layer into a carbon layer;
(g) forming a lithophilic surface on the carbon layer by heating the metal substrate and the carbon layer in an oxygen-containing environment, the lithophilic surface comprising a plurality of -hydroxyl groups and/or -carboxyl groups covalently bonded to the carbon layer; and
(h) applying lithium to the metal substrate over the carbon layer to form the lithium metal negative electrode, wherein the lithium is applied to the metal substrate such that a continuous layer of lithium chemically bonds to the lithophilic surface on the carbon layer via a plurality of hydrogen bonds.

16. A battery that cycles lithium ions, the battery comprising:
a negative electrode current collector having a first major surface, an opposite second major surface, and a plurality of perforations extending therethrough, the plurality of perforations being defined by wall surfaces extending from the first major surface to the second major surface of the negative electrode current collector, wherein the negative electrode current collector has a layered structure comprising:
a metal substrate; and
a carbon layer formed in situ on the metal substrate, the carbon layer defining the first major surface of the negative electrode current collector; and
a lithium metal layer deposited on the first major surface of the negative electrode current collector,
wherein the lithium metal layer is chemically bonded to the carbon layer via a plurality of hydrogen bonds.

17. The battery of claim 16, wherein the plurality of perforations have at least one cross-sectional dimension of greater than or equal to about 2 micrometers and less than or equal to about 1 millimeter.

18. The battery of claim 16, wherein the negative electrode current collector has a thickness of greater than or equal to about 1 micrometer and less than or equal to about 4 millimeters.

19. The battery of claim 16, wherein the carbon layer has a thickness of greater than or equal to about 10 nanometers and less than or equal to about 100 nanometers.

20. The battery of claim 16, wherein the lithium metal layer extends into the plurality of perforations in the negative electrode current collector, from the first major surface toward the second major surface thereof, and wherein the lithium metal layer has a thickness of greater than or equal to about 1 micrometer to less than or equal to about 30 micrometers.
